(19) United States
(12) Patent Application Publication
(10) Pub. No.: US 2018/0278079 A1
(43) Pub. Date: Sep. 27, 2018

(54) Apparatus for Wireless Power Transmission Between an External Power Source and an Electric Mobility Vehicle

(71) Applicant: Wheel Charge Technologies LLC, Deerfield Beach, FL (US)

(72) Inventors: Brian Maxfield, Lambton Shores (CA); Andrew Walker, Fort Lauderdale, FL (US); James Lester, Boca Raton, FL (US); Wing Ming Lam, Hong Lok Yuen (HK)

(21) Appl. No.: 15/993,586

(22) Filed: May 30, 2018

Related U.S. Application Data
(63) Continuation-in-part of application No. 15/393,133, filed on Dec. 28, 2016.
Application No. 15/393,133 is a continuation-in-part of application No. 14/613,063, filed on Feb. 3, 2015, now Pat. No. 9,868,625.
Application No. 14/613,063 is a continuation-in-part of application No. 13/856,010, filed on Apr. 3, 2013, now Pat. No. 9,567,202.
Application No. 13/856,010 is a continuation-in-part of application No. PCT/US2012/058830, filed on Oct. 5, 2012.
Application No. PCT/US2012/058830 is a continuation-in-part of application No. 13/403,185, filed on Feb. 23, 2012, now Pat. No. 9,079,759.
(60) Provisional application No. 62/512,586, filed on May 30, 2017.
(60) Provisional application No. 61/585,471, filed on Jan. 11, 2012.

(51) Int. Cl. H02J 7/02; H02J 50/12; H02J 7/00; A61G 5/04

(52) U.S. Cl. CPC H02J 7/025; H02J 50/12; B62K 5/01; A61G 5/04; H02J 7/0047

(57) ABSTRACT

Disclosed is an apparatus for wireless power transmission between an external power source and an electric mobility vehicle.

The current application claims a priority to the U.S. Provisional Patent application serial number 62/512,586 filed on May 30, 2017.

### FIELD OF THE INVENTION

The present invention relates generally to power charging devices. More particularly, the present invention is a wireless electric power charger and power supply system that can be used with any chargeable devices such as electric wheelchairs providing an easier and more convenient method of charging.

### BACKGROUND OF THE INVENTION

Elderly people may have limited mobility due to old age and other factors requiring them to use devices such as electric wheelchairs to maneuver around areas. These devices need to be charged periodically to have enough energy to function throughout the day. Charging the device requires the person to make a number of physical movements. With limited mobility, this is often a difficult task for the elderly.

It is therefore an objective of the present invention to provide a wireless electric power charger and power supply system that can be used with any chargeable devices such as electric wheelchairs providing an easier and more convenient method of charging. The present invention includes a power charger, which can be connected to the charging section of a device such as an electric wheelchair. The present invention includes a power supply which communicates with the power charger through a handle piece. The power supply can be plugged into as standard wall outlet to receive energy to power the power charger through the handle piece. The handle piece provides energy to the power charger based on the theory of magnetic resonance and magnetic field transformation. A user can easily and conveniently charge a device using the present invention.

### BRIEF DESCRIPTION OF THE DRAWINGS

FIG. 1 is a front view of the power supply with the handle piece magnetically attached.

FIG. 2 is a side view of the power supply with the handle piece magnetically attached.

FIG. 3 is a perspective view of the power supply with the handle piece magnetically attached.

FIG. 4 is a side view of the power supply with the handle piece magnetically attached.

FIG. 5 is an image displaying the power charger connected to an electric wheelchair.

FIG. 6 is an image displaying the power supply.

FIG. 7 is an image displaying the present invention connected to an electric wheelchair.

FIG. 8 is an image displaying the present invention connected to an electric scooter.

FIG. 9 is an image displaying the power charger connected to an electric scooter.

FIG. 10 is an image displaying the electromagnetic (EM) transmitter and the EM receiver in EM communication with each other.

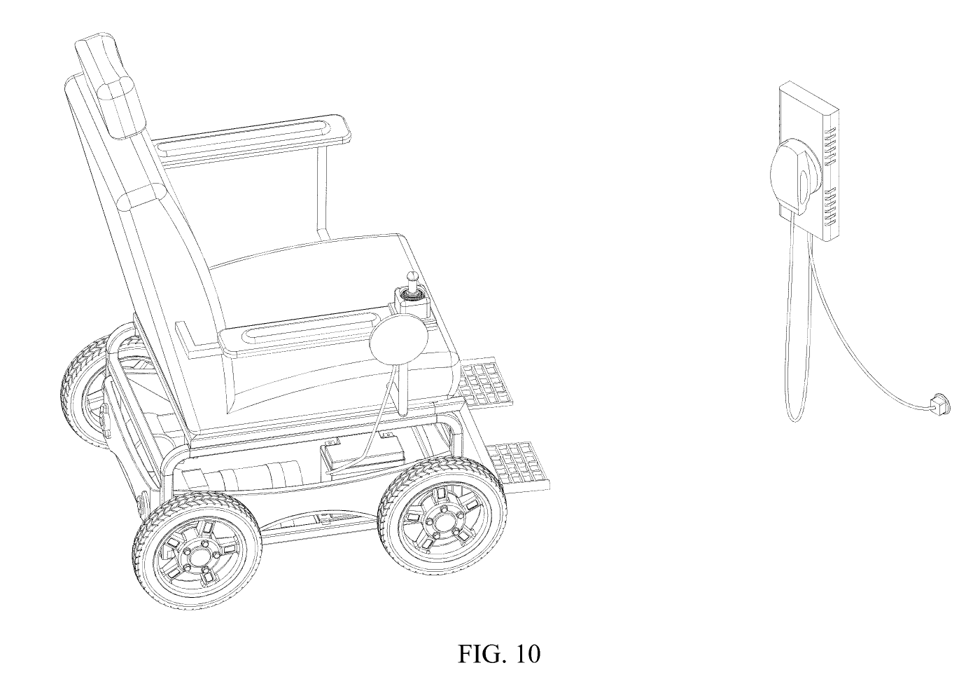

FIG. 11 is an image displaying the EM transmitter and the EM receiver not in EM communication with each other.

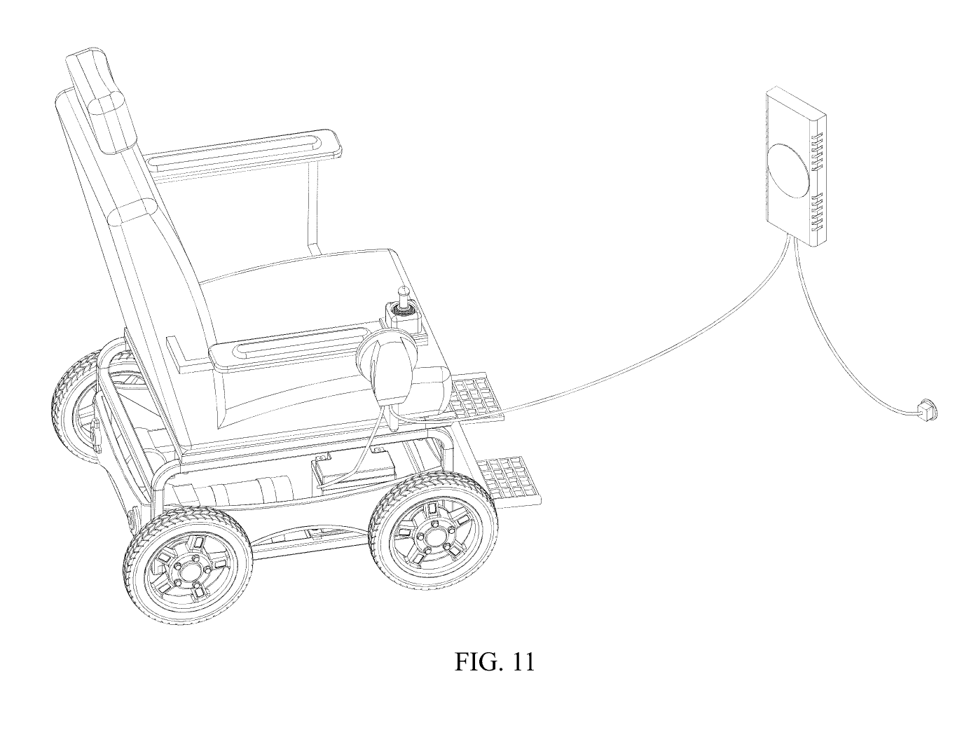

### DETAILED DESCRIPTION OF THE INVENTION

All illustrations of the drawings are for the purpose of describing selected versions of the present invention and are not intended to limit the scope of the present invention.

The present invention is an apparatus for wireless power transmission between an external power source and an electric mobility vehicle. The present invention allows a user with limited physical mobility to electrically connect the present invention to an electric mobility vehicle so that the portable power source of the electric mobility vehicle can be recharged. The electric mobility vehicle can be, but is not limited to, an electrically-powered wheelchair or an electrically-powered scooter. The preferred embodiment of the present invention comprises a power input terminal, a power output terminal, a power management system, an electromagnetic (EM) transmitter, and an EM receiver. The power input terminal is used to draw power from an external power source (e.g. an electric socket). The power output terminal is used to send power to a portable power source (e.g. a battery of an electric mobility vehicle). The power input terminal and the power output terminal are preferably some kind of electrical plug. The power management system processes the raw power from an external power source into a more usable format that can used to recharge a portable power source. The EM transmitter and the EM receiver allow the present invention to transfer power through a contactless break in the electrical circuit running from the power input terminal to the power output terminal. Moreover, the EM transmitter is a handheld electrical interface that can be move on and off the EM receiver, while the EM receiver is a fixed electrical interface that is externally mounted onto an electric mobility vehicle.

The general configuration of the aforementioned components allows the present invention to efficiently and effectively recharge an electric mobility vehicle with an external power source. The power input terminal is electrically connected to the power management system, which allows the present invention to manage the raw flow of electrical power from the power input terminal. The power management system is electrically connected to the EM transmitter so that the power management system is able to either continue the processed flow of electrical power to the EM transmitter if the recharging is not complete or stop the processed flow of electrical power to the EM transmitter if the recharging is complete. The EM transmitter is detachably attached to the EM receiver, which allows the user to readily attach the EM transmitter to the EM receiver if a portable power source of an electric mobility vehicle needs to be recharged and allows the user to readily detach the EM transmitter from the EM receiver if the portable power source of an electric mobility vehicle is done recharging and needs to be physically release from the rest of the present invention. In addition, the EM transmitter and the EM receiver are in EM communication with each other, wherein the EM communication is used to wirelessly transfer power from the EM transmitter to the EM receiver. Finally, the EM receiver is electrically connected to the power output terminal so that the EM receiver is able to route the processed flow of electrical power through the power output terminal and into a portable power source of an electric mobility vehicle.

Portions of the electrical circuit running from the power input terminal to the power output terminal can use wired connections in order to electricity between components of the present invention that are meant to be tethered together. A first electrical cable is a cord that tethers the power input terminal to the power management system and allows the power input terminal to be electrically connected to the power management system. The first electrical cable also provides the power input terminal with the freedom of movement to be plugged into an external power source (e.g. an electrical socket). A second electrical cable is a cord that tethers the power management system to the EM transmitter and allows the power management system to be electrically connected to the EM transmitter. The second electrical cable also provides the EM transmitter with the freedom of movement to be readily attached onto the EM receiver. A third electrical cable is a cord that tethers the EM receiver to the power output terminal and allows the EM receiver to be electrically connected to the power output terminal. The third electrical cable also provides the power output terminal with the freedom of movement to be guided though an electric mobility vehicle and plugged into its portable power source (e.g. a battery).

The present invention may further comprise a system housing that is used to enclose and protect the electronic components of the power management system. The system housing comprises a first panel and a second panel, which are positioned opposite to each other about the system housing. Moreover, a plurality of first magnets and a plurality of second magnets allows the EM transmitter to be selectively attached to the system housing while the EM transmitter is not in EM communication with the EM receiver. The plurality of first magnets is mounted within the system housing, adjacent to the first panel, and the plurality of second magnets is mounted onto the EM transmitter. Thus, if the plurality of second magnets is moved within the proximity of the plurality of first magnets, then the plurality of first magnets and the plurality of second magnets will attract and magnetically couple to each other so that the EM transmitter remains attached to the system housing. In addition, a wall-attachment mechanism allows the system housing to be mounted to a flat surface (e.g. a wall). The wall-attachment mechanism can be, but is not limited to, a two-piece interlocking fastener (e.g. a hook-and-loop fastener or a nut and bolt), a fixed fastener (e.g. a screw or a nail), or an adhesive. The wall-attachment mechanism is integrated into the second panel, which allows the EM transmitter to be readily attached to the system housing away from the flat surface.

The present invention may further comprise a transmitter housing that is used to enclose and protect the EM transmitter. The transmitter housing comprises a first engagement base and a first free base, which are positioned opposite to each other about the transmitter housing. Moreover, the plurality of second magnets and a plurality of third magnets allows the EM receiver to be selectively attached to the transmitter housing while the EM transmitter is in EM communication with the EM receiver. The plurality of second magnets is mounted within the transmitter housing, adjacent to the first engagement base, and the plurality of third magnets is mounted onto the EM receiver. Thus, if the plurality of second magnets is moved within the proximity of the plurality of third magnets, then the plurality of second magnets and the plurality of third magnets will attract and magnetically couple to each other so that the EM receiver remains attached to the transmitter housing. In addition, a handle allows the transmitter housing to be easily grasped with one hand. The handle is connected across the first free base, which allows the EM transmitter to be readily held by a user and to be move from the system housing to the EM receiver or vice versa.

The present invention may further comprise a receiver housing that is used to enclose and protect the EM receiver. The receiver housing comprises a second engagement base and a second free base, which are positioned opposite to each other about the receiver housing. From the other perspective, the plurality of second magnets and the plurality of third magnets allows the EM transmitter to be selectively attached to the receiver housing while the EM transmitter is in EM communication with the EM receiver. The plurality of second magnets is mounted onto the EM transmitter housing, and the plurality of third magnets is mounted within the receiver housing, adjacent to the second engagement base. Thus, if the plurality of second magnets is moved within the proximity of the plurality of third magnets, then the plurality of second magnets and the plurality of third magnets will attract and magnetically couple to each other so that the EM transmitter remains attached to the receiver housing. In addition, a vehicle-attachment mechanism allows the receiver housing to be mounted to an easily-accessible portion of an electric mobility vehicle. Similar to the wall-attachment mechanism, the vehicle-attachment mechanism can be, but is not limited to, a two-piece interlocking fastener (e.g. a hook-and-loop fastener or a nut and bolt), a fixed fastener (e.g. a screw or a nail), or an adhesive. The vehicle-attachment mechanism is integrated into the second free base, which allows the EM transmitter to be readily attached to the receiver housing away from the electric mobility vehicle. The vehicle-attachment mechanism allows the EM receiver to be retrofitted onto an existing electric mobility vehicle.

The present invention is also able to notify the user of the current power level of a portable power source of an electric mobility device and to notify whether or not the EM transmitter still needs to be in EM communication with the EM receiver. Thus, the present invention may further comprise an indicator light, a proximity sensor, and a voltage sensor. The proximity sensor is mounted onto the power management system so that the proximity sensor is able to detect when the EM transmitter is attached onto the system housing. The voltage sensor is electrically integrated into the power output terminal so that the voltage sensor is able to take a current voltage measurement of the portable power source for an electric mobility device. In addition, the proximity sensor and the voltage sensor are electronically connected a microcontroller for the power management system so that the microcontroller is able to process the sensor readings and output a notification to the user. The indicator light is electronically connected to the microcontroller and allows the microcontroller to visually output the notification. In the preferred embodiment, the indicator light turns to the color blue if the EM transmitter is attached to the system housing, the color red if the present invention is recharging the portable power source of an electric mobility vehicle, or the color green if the portable power source is fully charged. The indicator light is mounted onto the power management system, which allows for easy visibility at a centralized location.

The EM transmitter and the EM receiver can be configured in a variety of ways to wirelessly transfer power through EM communication. The preferred way is to configure the EM transmitter into a transmitting resonator and the EM receiver into a receiving resonator that would allow for magnetic resonance power transfer as the EM communication between the EM transmitter and the EM receiver. An alternative way is to configure the EM transmitter into a transmitting coil and the EM receiver into a receiving coil that would allow for inductive power transfer as the EM communication between the EM transmitter and the EM receiver.

### Alternative Description

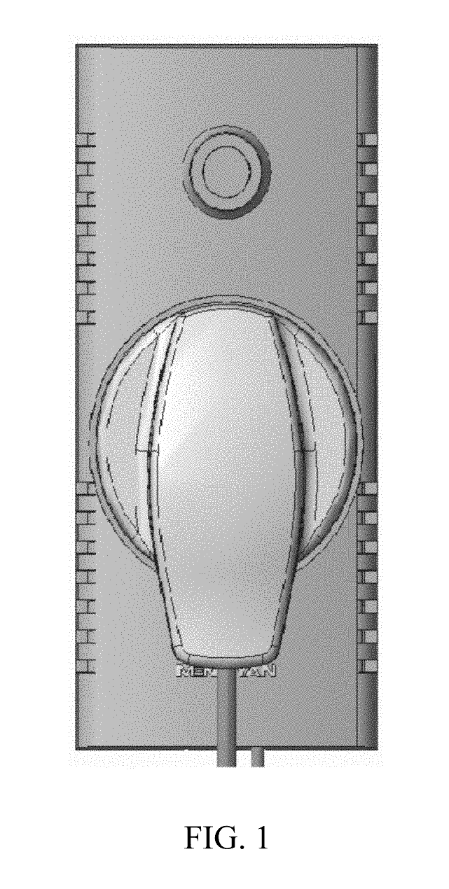

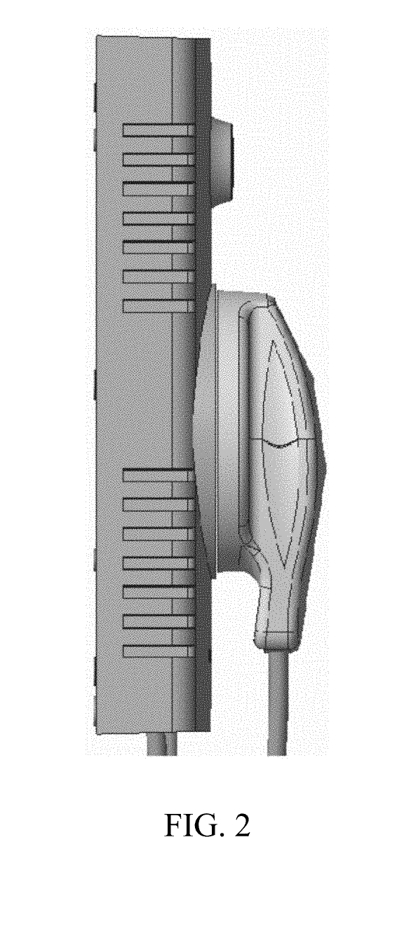

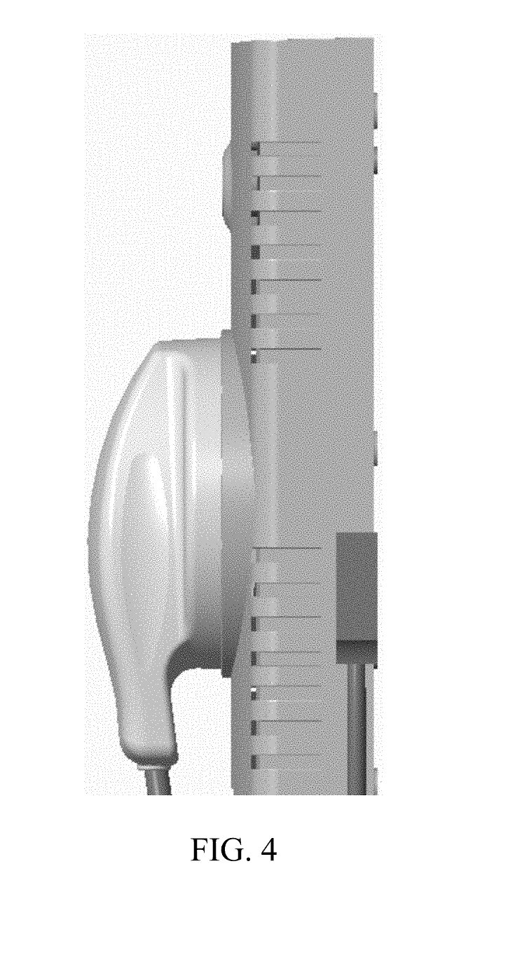

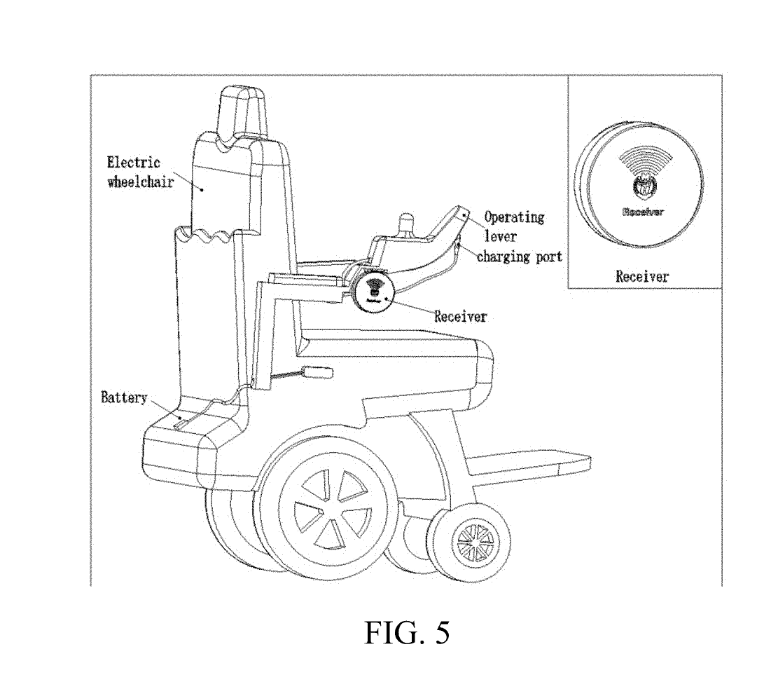

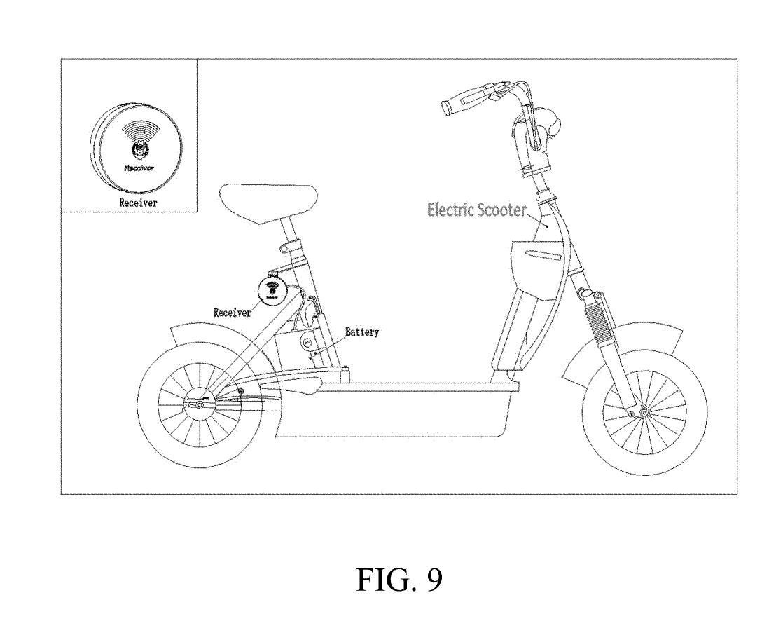

In reference to FIGS. 1 to 9, the present invention is a wireless electric power charger and power supply system comprising a power charger and a power supply. With reference to FIGS. 5 and 9, the power charger may be any size and shape. The power charger may be composed of any material. The power charger comprises a first casing. The first casing may be any size and shape. The first casing may be composed of any material. The first casing comprises a first electrical compartment, a front portion, a lateral portion, and a rear portion. The front portion being connected perpendicular and perimetrically to the lateral portion. The rear portion being connected perpendicular and perimetrically to the lateral portion opposite the front portion. The first electrical compartment is a recessed area within the casing. The first electrical compartment comprises a receiver component and a first circuit board. The receiver component may be any receiver device able to receive signals from a transmitter device. The first circuit board may be any connection interface able to connect multiple devices in a circuit. The first circuit board comprises a first magnetic circuit. The receiver component is connected to the first circuit board through a wire. The front portion comprises a first inner section. The first inner section is the inner area of the casing at the front portion. The first inner section comprises a first plurality of magnets. A first power cord extends from the electrical compartment out the lateral portion. The first power cord is connected to the first circuit board. The first power cord comprises a connection component. The connection component allows the power charger to be connected to the charging port of a device such as an electric wheelchair. The rear portion comprises a first mounting section. The first mounting section may comprise any type of mounting apparatus allowing the user to mount the power charger to a part of a device such as an electric wheelchair.

In reference to FIGS. 1-4, 6, and 9, the power supply comprises a second casing. The second casing may be any shape and size. The second casing may be composed of any material. The second casing comprises a second electrical compartment, front surface, a rear surface, a left-side surface, a right -side surface, a bottom surface, and a top surface. The second electrical compartment is a recessed area within the casing. The second electrical compartment comprises a transmitter component, a second circuit board and a microcontroller. The transmitter component maybe any transmitter device able to distribute signals to a receiver device. The second circuit board may be any connection interface able to connect multiple devices in a circuit. The transmitter component is connected to the second circuit board through a wire. With reference to FIG. 1, the front surface comprises a protruded surface and an indicator light. The protruded surface is positioned at the center of the front surface and extends from the front surface. The protruded surface may be shape and size. The protruded surface comprises a second inner section. The second inner section is a recessed area within the protruded surface. The second inner section comprises a second plurality of magnets. The indicator light may be any type of light. The indicator may be positioned anywhere on the front surface. Preferably, the indicator light is an LED light which can emit different colors and is positioned along the vertical centerline of the front surface above the protruded surface. The indicator light is connected to the second circuit board through a wire.

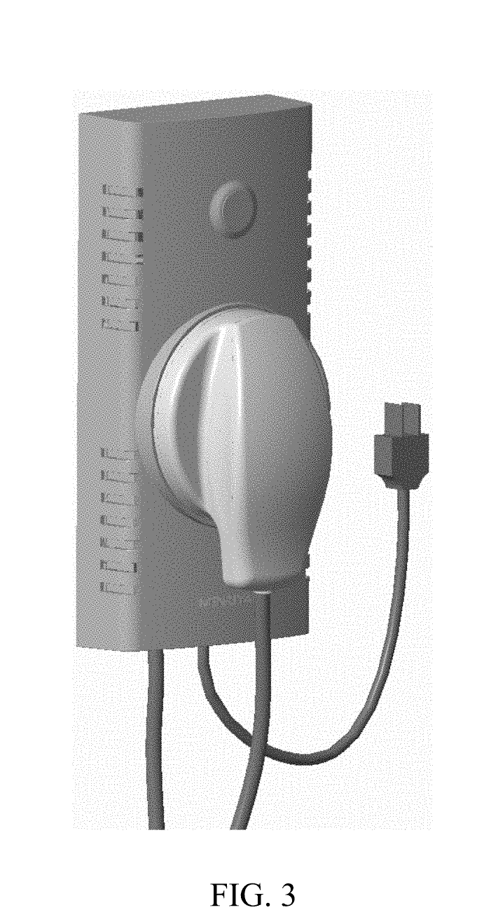

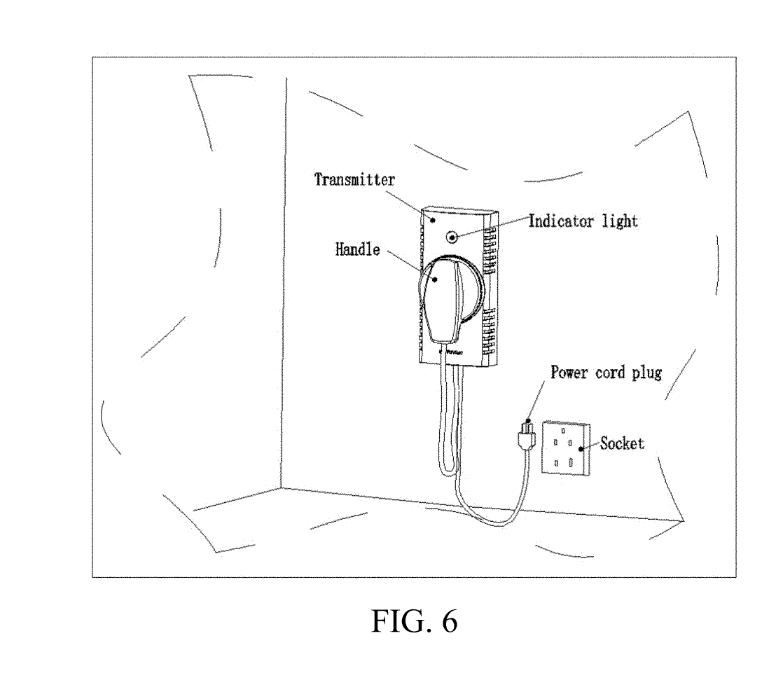

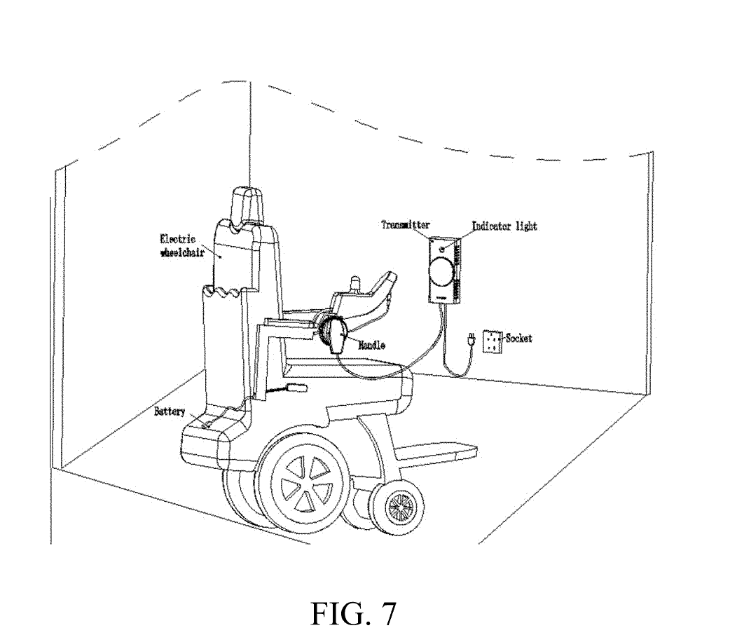

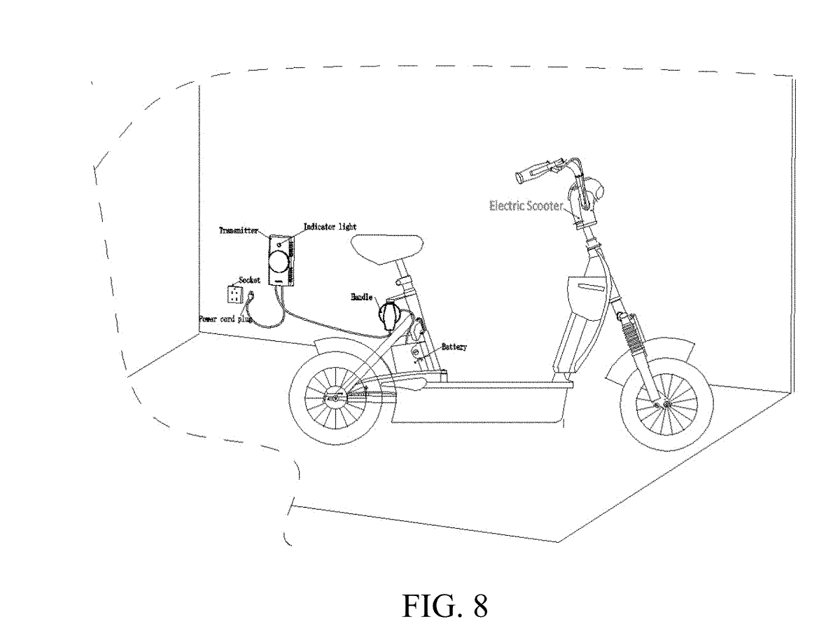

The rear surface comprises a second mounting section. The second mounting section may comprise any type of mounting apparatus allowing the user to mount the power supply to a wall or other surface. A first cord extends from the second electrical compartment and out the bottom surface of the power supply. The first cord is connected to the second circuit board. The first cord comprises a connection plug. The connection plug allows the power supply to be connected to a standard wall outlet. A second cord extends from the second electrical compartment and out the bottom section. The end of the cord, not connected to the power supply, is connected to a handle piece. The handle piece may be any shape and size. The handle piece comprises a main portion and a secondary portion. The main portion comprises a grip and a third electrical compartment. The grip allows the user to easily hold the handle piece. The third electrical compartment is a recessed area within the main portion of the handle piece. The third electrical compartment comprises a third circuit board. The end of the second cord, not connected to the power supply, is connected to the third circuit board. The third circuit board comprises a second magnetic circuit. The secondary portion is a flat surface of the handle piece. The secondary portion comprises a third inner section. The third inner section is an inner area of the secondary portion comprises a third plurality of magnets. With reference to FIGS. 3 and 6, the handle piece may be magnetically to the protruded surface of the power supply through the second plurality of magnets and the third plurality of magnets. With reference to FIGS. 7 and 8, the handle may be magnetically attached to the front portion of the power charger through the first plurality of magnets and the third plurality of magnets. Through the first magnetic circuit of the power charger and the second magnetic circuit of the handle piece, the handle piece may wirelessly provide energy to the power charger based on the theory of magnetic resonance and magnetic field transformation. Through the programming of the microcontroller, the indicator light may emit different colors when in standby mode, in battery charging mode and when the battery of a device is fully charged. Also, the microcontroller is programmed to prevent the device from being used when charging.

Although the invention has been explained in relation to its preferred embodiment, it is to be understood that many other possible modifications and variations can be made without departing from the spirit and scope of the invention as hereinafter claimed.

What is claimed is:

1. An apparatus for wireless power transmission between an external power source and an electric mobility vehicle comprises:
a power input terminal;
a power output terminal;
a power management system;
an electromagnetic (EM) transmitter;
an EM receiver;
the power input terminal being electrically connected to the power management system;
the power management system being electrically connected to the EM transmitter;
the EM receiver being electrically connected to the power output terminal;
the EM transmitter and the EM receiver being detachably attached to each other; and
the EM transmitter and the EM receiver being in EM communication with each other, wherein the EM communication is used to wirelessly transfer power from the EM transmitter to the EM receiver.

2. The apparatus for wireless power transmission between an external power source and an electric mobility vehicle as claimed in claim 1 comprises:
a first electrical cable; and
the power input terminal being electrically connected to the power management system through the first electrical cable.

3. The apparatus for wireless power transmission between an external power source and an electric mobility vehicle as claimed in claim 1 comprises:
a second electrical cable; and
the power management system being electrically connected to the EM transmitter through the second electrical cable.

4. The apparatus for wireless power transmission between an external power source and an electric mobility vehicle as claimed in claim 1 comprises:
a third electrical cable; and
the EM receiver being electrically connected to the power output terminal through the third electrical cable.

5. The apparatus for wireless power transmission between an external power source and an electric mobility vehicle as claimed in claim 1 comprises:
a system housing;
the system housing comprises a first panel and a second panel;
the first panel and the second panel being positioned opposite to each other about the system housing; and
the power management system being enclosed within the system housing.

6. The apparatus for wireless power transmission between an external power source and an electric mobility vehicle as claimed in claim 5 comprises:
a plurality of first magnets;
a plurality of second magnets;
the plurality of first magnets being mounted within the system housing, adjacent to the first panel; and
the plurality of second magnets being mounted onto the EM transmitter.

7. The apparatus for wireless power transmission between an external power source and an electric mobility vehicle as claimed in claim 5 comprises:
a wall-attachment mechanism; and
the wall-attachment mechanism being integrated into the second panel.

8. The apparatus for wireless power transmission between an external power source and an electric mobility vehicle as claimed in claim 1 comprises:
a transmitter housing;
the transmitter housing comprises a first engagement base and a first free base;
the EM transmitter being enclosed within the transmitter housing;
the first engagement base and the first free base being positioned opposite to each other about the transmitter housing; and
the first engagement base being positioned in between the EM transmitter and the EM receiver.

9. The apparatus for wireless power transmission between an external power source and an electric mobility vehicle as claimed in claim 8 comprises:
a plurality of second magnets;
a plurality of third magnets;
the plurality of second magnets being mounted within the transmitter housing, adjacent to the first engagement base; and
the plurality of third magnets being mounted onto the EM receiver.

10. The apparatus for wireless power transmission between an external power source and an electric mobility vehicle as claimed in claim 8 comprises:
a handle; and
the handle being connected across the first free base.

11. The apparatus for wireless power transmission between an external power source and an electric mobility vehicle as claimed in claim 1 comprises:
a receiver housing;
the receiver housing comprises a second engagement base and a second free base;
the EM receiver being enclosed within the receiver housing;
the second engagement base and the second free base being positioned opposite to each other about the receiver housing; and
the second engagement base being positioned in between the EM transmitter and the EM receiver.

12. The apparatus for wireless power transmission between an external power source and an electric mobility vehicle as claimed in claim 11 comprises:
a plurality of second magnets;
a plurality of third magnets;
the plurality of second magnets being mounted onto the EM transmitter; and
the plurality of third magnets being mounted within the receiver housing, adjacent to the second engagement base.

13. The apparatus for wireless power transmission between an external power source and an electric mobility vehicle as claimed in claim 11 comprises:
a vehicle-attachment mechanism; and
the vehicle-attachment mechanism being integrated into the second free base.

14. The apparatus for wireless power transmission between an external power source and an electric mobility vehicle as claimed in claim 1 comprises:
an indicator light;
a proximity sensor;
a voltage sensor;
the power management system comprises a microcontroller;
the proximity sensor being mounted onto the power management system;
the proximity sensor being electronically connected to the microcontroller;
the voltage sensor being electrically integrated into the power output terminal;
the voltage sensor being electronically connected to the microcontroller;
the indicator light being mounted onto the power management system; and
the indicator light being electronically connected to the microcontroller.

15. The apparatus for wireless power transmission between an external power source and an electric mobility vehicle as claimed in claim 1, wherein the EM transmitter and the EM receiver are configured for magnetic resonance power transfer as the EM communication between the EM transmitter and the EM receiver.
